(19) United States
(12) Patent Application Publication
(10) Pub. No.: US 2021/0048597 A1
(43) Pub. Date: Feb. 18, 2021

(54) LENS MODULE AND ELECTRONIC DEVICE HAVING THE SAME

(71) Applicant: TRIPLE WIN TECHNOLOGY(SHENZHEN) CO.LTD., Shenzhen (CN)

(72) Inventors: JIAN-CHAO SONG, Shenzhen (CN); SHIN-WEN CHEN, Tu-Cheng (TW); JING-WEI LI, Shenzhen (CN); SHENG-JIE DING, Shenzhen (CN)

(21) Appl. No.: 16/556,640

(22) Filed: Aug. 30, 2019

(30) Foreign Application Priority Data
Aug. 14, 2019 (CN) 201910751018.8

(51) Int. Cl. G02B 7/02; G02B 7/00; G01J 1/04

(52) U.S. Cl. CPC G02B 7/022; G01J 1/0403; G01J 1/0411; G02B 7/006

(57) ABSTRACT

A lens module includes a base and a filter. The base includes a through hole and a first thread. The through hole is surrounded by an inner surface of the base. The first thread is formed on the inner surface. The filter includes a sidewall and a second thread forming on the sidewall. The filter is received in the through hole, the second thread is engaged with the first thread. The disclosure also provides an electronic device having the lens module.

### FIELD

The subject matter herein generally relates to a lens module and an electronic device having the lens module.

### BACKGROUND

With the miniaturization of electronic products, the lens module is an important component in electronic products, and its size design will have a greater impact on the overall sizes of electronic products.

Therefore, there is room for improvement within the art.

### BRIEF DESCRIPTION OF THE DRAWINGS

Implementations of the present disclosure will now be described, by way of embodiments, with reference to the attached figures.

FIG. 1 is a diagram of an embodiment of a lens module.

FIG. 2 is an exploded, diagrammatic view of the lens module of FIG. 1.

FIG. 3 is exploded, diagrammatic view of the lens module of FIG. 1 viewed from another angle.

FIG. 4 is a cross-sectional view of the lens module taken along IV-IV line of FIG. 1.

FIG. 5 is diagram of an embodiment of an electronic device having the lens module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, Group, series, and the like.

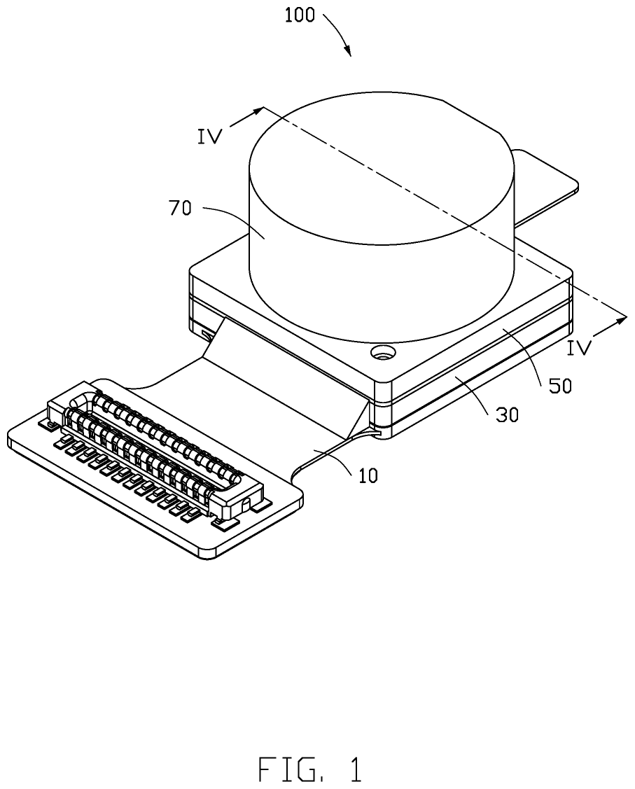

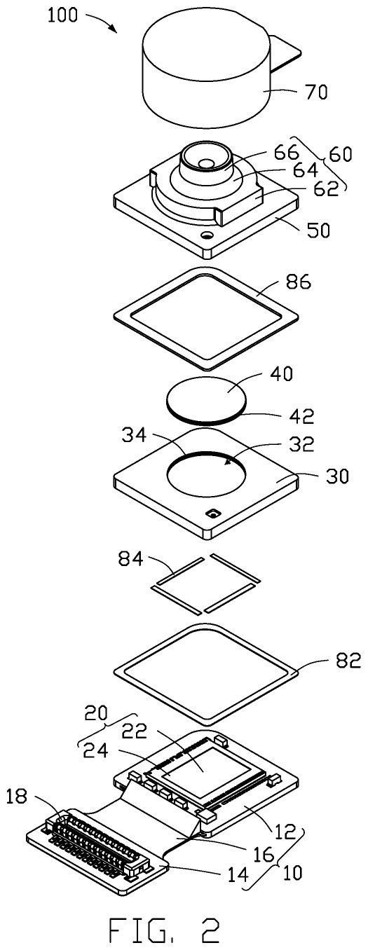

FIG. 1 illustrates an embodiment of a lens module 100. Referring to FIG. 2, the lens module 100 includes a circuit board 10, a photosensitive chip 20, a base 30, a filter 30, lens holder 50, and a lens 60.

In at least one embodiment, the circuit board 10 may be a flexible circuit board, a rigid circuit board, or a rigid-flexible circuit board. In an embodiment, the circuit board 10 is a rigid-flexible circuit board including a first rigid portion 12, a second rigid portion 14, a flexible portion 16 connecting the first rigid portion 12 and the second rigid portion 14.

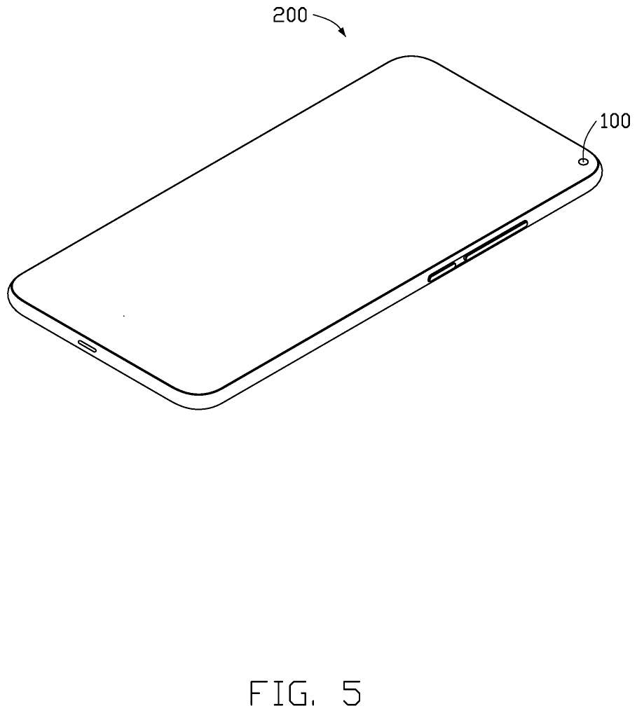

At least one electronic connecting element 18 is mounted on a surface of the second rigid portion 14. When the lens module 100 is applied to an electronic device 200 (shown in FIG. 5), the electronic connecting element 18 is configured to transmit signals between the lens module 100 and other components of the electronic device 200. In at least one embodiment, the electronic connecting element 18may be a connector or a gold finger.

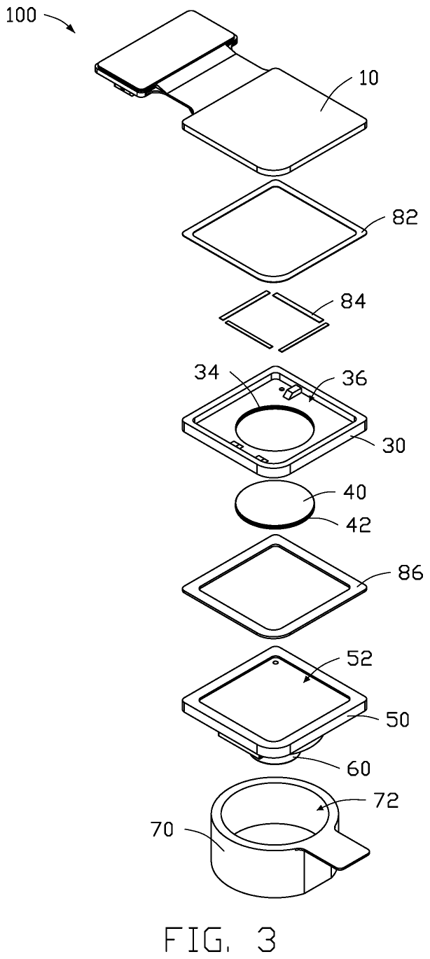

Referring to FIGS. 2 and 3, a photosensitive chip 20 and a plurality of electronic elements (not shown) are mounted on a surface of the first rigid portion 12. In at least one embodiment, the photosensitive chip 20, the plurality of electronic elements and the electronic connecting element 18 are mounted on a same surface of the circuit board 10. The electronic elements may be at least one of resistors, capacitors, diodes, triodes, relays and electrically erasable programmable read-only memory (EEPROM).

The base 30 is mounted on the surface of the first rigid portion 12 with the photosensitive chip 20.

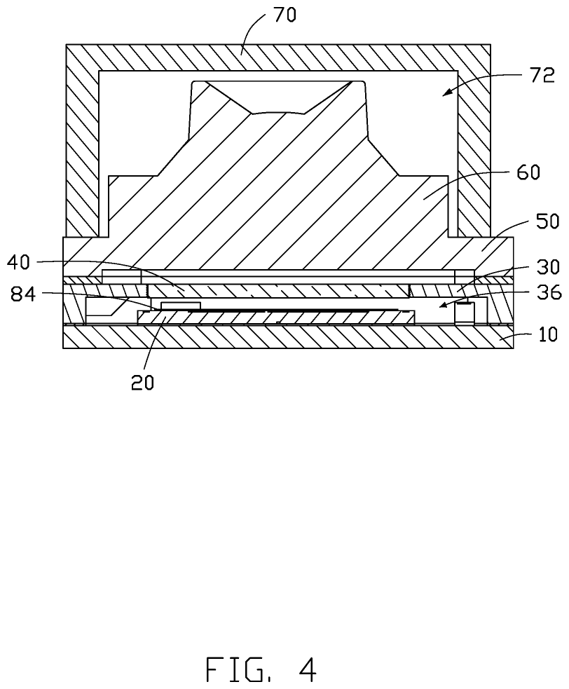

Referring to FIG. 4, the photosensitive chip 20 includes a photosensitive region 22 and a non-photosensitive region 24 protruding from a periphery of the photosensitive region 22 to surround the photosensitive region 24.

The base 30 is a hollow structure, and connects to the circuit board 10 by a first adhesive layer 82. A through hole 32 is defined on the base 30 to correspond to the photosensitive region 22 of the photosensitive chip 20. The through hole 32 is circular. An inner surface of the base 30 surrounds to define the through hole 32. A first thread 34 is formed on the inner surface of the base 30. A portion of a surface of the base 30 facing the circuit board 10 is recessed toward a surface of the base 30 facing away from the circuit board 10 to define a first recess 36. The first recess 36 communicates with the through hole 32. The photosensitive chip 20 is received in the first recess 36.

The filter 40 is circular. A second thread 42 is formed on a sidewall of the filter 40 to cooperate with the first thread 34. The filter 40 is engaged with the first thread 34 of the base 30 by the second thread 42. So that the filter 40 can be fixed on the base 30 without an adhesive structure between the filter 40 and the base 30, thereby reducing a size of the lens module 100 along a direction perpendicular to the sidewall of the filter 40.

In at least one embodiment, the photosensitive chip 20 may be substantially rectangular. A second adhesive layer 84 is formed on a surface of the non-photosensitive region 24 facing away from the first rigid portion 12, to adsorb dirt and dust generated by meshing the filter 40 and base 30, thereby preventing the dirt and the dust from entering the photosensitive region 22. As a result, a yield rate of the lens module 100 can be improved.

In at least one embodiment, the lens holder 50 is mounted on the surface of the base 30 facing away from the circuit board 10 by a third adhesive layer 86. The lens holder 50 may be generally cuboid. A receiving hole 52 is defined on the lens holder 50.

The lens 60 is received in the receiving hole 52 of the lens holder 50. The lens 60 and the lens holder 50 may be assembled or integrally formed. In at least one embodiment, the lens 60 and the lens holder 50 are integrally formed. The lens 60 includes a first lens portion 62, a second lens portion 64 and a third portion 66. The second lens portion 64 is located between the first lens portion 62 and the third lens portion 66. A diameter of the second lens portion 64 is less than a diameter of the first lens portion 62, and a diameter of the third lens portion 66 is less than the diameter of the second lens portion 64. In at least one embodiment, the first lens portion 62, the second lens portion 64 and the third portion 66 may be integrally formed.

The lens module 100 may further include a protective part 70. A second recess 70 is defined on the protective part 70 to receive the lens 60. The protective part 70 cooperates with the lens holder 50 to protect the lens 60, for example, to prevent dust from contaminating the lens 60.

Referring to FIG. 5, the lens module 100 can be used in an electronic device 200. The electronic device 200 can be a mobile phone, a laptop, a wearable device, a camera, a monitoring device or others.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lens module comprising:
a base comprising:
a through hole surrounded by an inner surface of the base; and
a first thread formed on the inner surface; and
a filter comprising a sidewall and a second thread forming on the sidewall;
wherein the filter is received in the through hole, the second thread is engaged with the first thread.

2. The lens module of claim 1, wherein the through hole is circular, and the filter is circular.

3. The lens module of claim 1, wherein the lens module further comprises a photosensitive chip and a first adhesive layer, the photosensitive chip comprises a photosensitive region and a non-photosensitive region protruding on a periphery of the photosensitive region to surround the photosensitive region, the photosensitive region corresponds to the through hole, the adhesive layer is formed a surface of the non-photosensitive region facing the filter.

4. The lens module of claim 3, wherein the lens module further comprises a circuit board, the base and a surface of the photosensitive chip facing away from the filter are mounted on the circuit board.

5. The lens module of claim 4, wherein a portion of a surface of the base facing the circuit board is recessed toward the filter to define a first recess to receive the photosensitive chip.

6. The lens module of claim 4, wherein the circuit board comprises a first rigid portion, a second rigid portion, a flexible portion connecting each of the first rigid portion and the second rigid portion, the base and the photosensitive chip are mounted on the first rigid portion.

7. The lens module of claim 6, wherein the lens module further comprises an electronic connecting element, the electronic connecting element is mounted on the second rigid portion to transmit signals.

8. The lens module of claim 1, wherein the lens module further comprises a lens holder and a lens, the lens holder is mounted on the base, the lens holder defines a receiving hole, the lens is received in the receiving hole.

9. The lens module of claim 8, wherein the lens comprises a first lens portion, a second lens portion and a third lens portion, the second lens portion is located between the first lens portion and the third lens portion, a diameter of the second lens portion is less than a diameter of the first lens portion, and a diameter of the third lens portion is less than the diameter of the second lens portion.

10. An electronic device comprising:
a lens module comprising:
a base comprising:
a through hole surrounded by an inner surface of the base; and
a first thread formed on the inner surface; and
a filter comprising a sidewall and a second thread forming on the sidewall;
wherein the filter is received in the through hole, the second thread is engaged with the first thread.

11. The electronic device of claim 10, wherein the through hole is circular, and the filter is circular.

12. The electronic device of claim 10, wherein the lens module further comprises a photosensitive chip and a first adhesive layer, the photosensitive chip comprises a photosensitive region and a non-photosensitive region protruding from a periphery of the photosensitive region to surround the photosensitive region, the photosensitive region corresponds to the through hole, the adhesive layer is formed a surface of the non-photosensitive region facing the filter.

13. The electronic device of claim 12, wherein the lens module further comprises a circuit board, the base and a surface of the photosensitive chip facing away from the filter are mounted on the circuit board.

14. The electronic device of claim 13, wherein a portion of a surface of the base facing the circuit board is recessed toward the filter to define a first recess to receive the photosensitive chip.

15. The electronic device of claim 13, wherein the circuit board comprises a first rigid portion, a second rigid portion, a flexible portion connecting each of the first rigid portion and the second rigid portion, the base and the photosensitive chip are mounted on the first rigid portion.

16. The electronic device of claim 15, wherein the lens module further comprises an electronic connecting element, the electronic connecting element is mounted on the second rigid portion to transmit signals.

17. The electronic device of claim 10, wherein the lens module further comprises a lens holder and a lens, the lens holder is mounted on the base, the lens holder defines a receiving hole, the lens is received in the receiving hole.

18. The electronic device of claim 17, wherein the lens comprises a first lens portion, a second lens portion and a third lens portion, the second lens portion is located between the first lens portion and the third lens portion, a diameter of the second lens portion is less than a diameter of the first lens portion, and a diameter of the third lens portion is less than the diameter of the second lens portion.
